(19) United States
(12) Patent Application Publication
(10) Pub. No.: US 2010/0104936 A1
(43) Pub. Date: Apr. 29, 2010

(54) Battery with a Heat Conducting Plate

(75) Inventors: Jens Meintschel, Bensdorf (DE); Dirk Schroeter, Winnenden (DE); Petra Schulz, Esslingen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLER AG, STUTTGART (DE)

(21) Appl. No.: 12/528,751

(22) PCT Filed: Feb. 27, 2008
(86) PCT No.: PCT/EP08/01528

§ 371 Date: Dec. 15, 2009

(30) Foreign Application Priority Data
Feb. 27, 2007 (DE) 10 2007 010 745.7

(51) Int. Cl. H01M 10/50

(52) U.S. Cl. 429/120

(57) ABSTRACT

A battery has a heat conducting plate for temperature control, and a plurality of parallel and/or serially connected single cells which are thermally coupled to the heat conducting plate. A channel structure is arranged in the heat conducting plate for guiding a flow of a heat conducting medium therein, and connection cross sections for the channel structure extend from the heat conducting plate. In the region of the poles of the single cells the heat conducting plate has bores through which the poles of the single cells extend. An insert piece which is made from an electrically insulating material and is arranged around the pole of a single cell, at least partially abuts the outer surface of the pole, and has at least one spacer extending radially from the pole. The spacer is arranged in the region of the pole between the cover of the single cell and the heat conducting plate.

### BACKGROUND AND SUMMARY OF THE INVENTION

This application is a national stage of PCT International Application No. PCT/EP2008/001528, filed Feb. 27, 208, which claims priority under 35 U.S.C.§119 to German Patent Application No. 10 2007 010 745.7, filed Feb. 27, 2007, the entire disclosure of which is herein expressly incorporated by reference.

The invention relates to a battery with a heat conducting plate for temperature control of the battery.

Germany patent document DE 197 24 020 A1 discloses a battery that has several single cells connected in parallel and/or in series, which are placed on a heat conducting plate, and are in thermal contact therewith. An evaporator section of a heat pipe is arranged in the heat conducting plate. The heat pipe extends out of the heat conducting plate, and out of the battery housing, so that the condensation section of the heat pipe is outside the heat conducting plate. With this arrangement of the heat pipe, the heat conducting plate (and thus the single cells) can be temperature-controlled, especially cooled during operation. Especially with Li ion batteries, an overload and/or a high current withdrawal can lead to a high pressure build-up of the single cells, which can finally lead to bursting of the cell housing of the respective single cells.

To ensure a specified pressure reduction, it is sensible to arrange a predetermined breaking point in the bottom of the housing of the single cell, so that the single cell can burst in a specified manner. To improve this pressure reduction, it is also sensible to provide the heat conducting plate with continuous bores or recesses below the setting surface of the single cells (referred to herein as “bursting windows”). The diameter of the bursting windows is slightly smaller than the outer diameter of the cell housing. The bursting windows, however, reduce the effective heat conducting cross section of the heat conducting plate, so that their possible efficiency is reduced.

One object of the invention is to provide a battery which is simple and cost-effective, with maximum efficiency of the heat conduction and an assembly space that is as small as possible.

This and other objects and advantages are achieved by the battery according to the invention, which includes an arrangement that can be disposed in the top region of the single cells, by the formation of a heat conducting plate according to the invention. Although the heat conducting plate also must be provided with bores, their surface is considerably smaller, so that the center surface-related effective heat conducting cross section is increased. In this manner, it is again possible with a constant entire heat conducting cross section to design the heat conducting plate thinner, and thus lighter. An insert piece of an electrically insulating material is arranged at one pole of a single cell, which abuts, at least in sections, at the outer surface of the pole and which comprises at least one spacer extending radially from the pole. As the spacer is arranged in the region of a pole between the cover of the single cell and the heat conducting plate, a short circuit between the heat conducting plate, cell housing, and/or the pole can be prevented reliably.

It is a further particular advantage of the invention, that differences caused by manufacturing tolerances in the region of these components can be compensated.

In a further arrangement of the invention, the spacer comprises a spacing collar extending radially from the pole and progressing at the edge of the insert piece in an uninterrupted continuous manner. With the spacing collar, a safe distance between the heat conducting plate and the cell cover is ensured, among other things, during mounting, even with higher tolerances and/or a careless assembly (for example, rotation of the insert piece).

In a further arrangement of the invention, the insert piece is made of a heat-conducting material, so that the pole can also be used for the heat management.

In a further arrangement of the invention, both poles of a single cell have a single (preferably one-piece) insert piece. This arrangement ensures a safe distance between the heat conducting plate and the cell cover, among other things during mounting, even with higher tolerances and/or a careless assembly, such as rotation of the insert piece.

In a further arrangement of the invention, the insert piece surrounds the outer surface of a pole especially completely, so that a safe conducting plate can be realized.

In a further embodiment of the invention, the cell housings and the heat conducting plate are joined to one another. In this manner, the gap between the cover of the cell housing and the heat conducting plate can be reduced from a minimum measure of 1.5 mm to consistently about 0.5 mm.

In further embodiments of the invention, an electrically insulating and preferably heat-conductive (most preferably highly heat-conductive) casting compound and/or foam is arranged within the battery housing in the gaps between the heat conducting plate on the one hand and the poles, the electrical cell connectors, the cell cover and the battery box cover, and the spaces between the single cells, are filled with an electrically insulating and preferably heat-conductive (most preferably highly heat-conductive) foam. The mentioned spaces are thus used more efficiently for heat conduction within the battery housing, and the stability of the entire battery housing is simultaneously increased. The probability of leakage current is especially reduced by filling the volume in the region of the cell connectors and the cover of the single cells in connection with the insert piece.

The single cells according to the invention are especially well adapted for use in high performance batteries, especially for at least partial drive of a motor vehicle for passenger transport.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a battery with a heat conducting plate arranged at the bottom;

FIG. 2 is a perspective view of a cell stack of a battery with a heat conducting plate arranged at the top;

FIG. 3 shows two single cells of the cell stack according to FIG. 2, with an insert piece arranged on and above the poles;

FIG. 4 shows a one-piece insert piece for two poles of a single cell;

FIG. 5 is a sectional view of the insert piece according to FIG. 5, taken along line V-V; and

FIG. 6 is a sectional enlargement of a longitudinal section through a cell stack according to FIG. 2 in a side view.

### DETAILED DESCRIPTION OF THE INVENTION

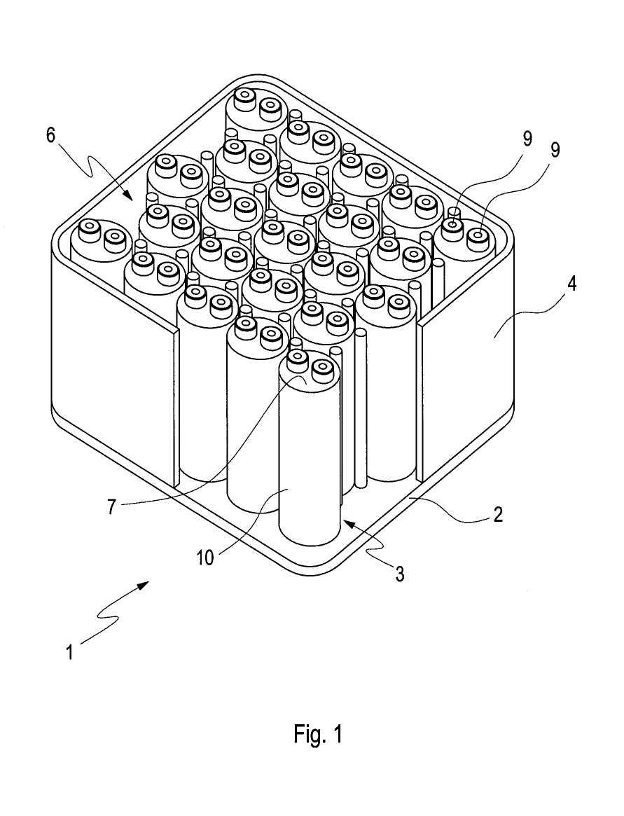

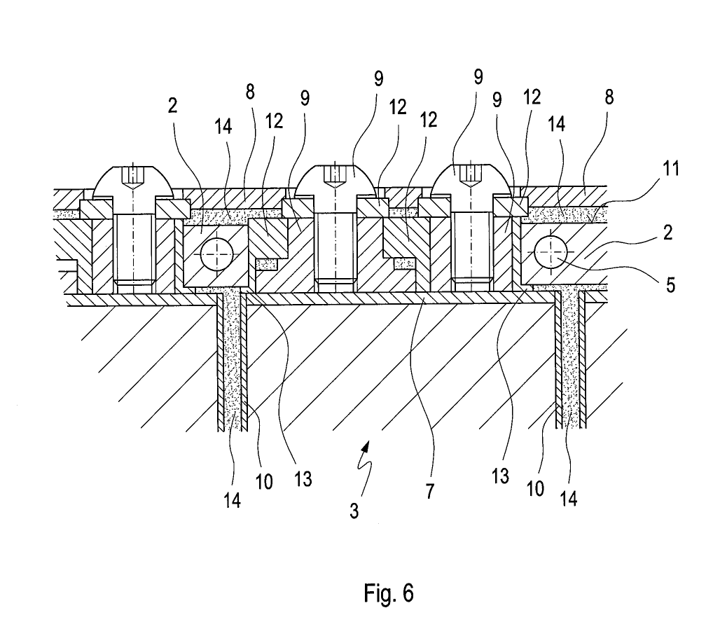

In FIG. 1 shows a known battery 1, which has a heat conducting plate 2 arranged at the bottom, and includes several single cells 3 connected electrically to one another. The single cells 3, which are preferably round in their cross section, are arranged preferably in a completely closed battery housing 4. Within the battery housing 4, the single cells 3 are placed on and thermally coupled to the heat conducting metal plate 2. Cooling channels 5 (FIG. 6) for conveying a heat conducting medium are arranged in the heat conducting plate 2. The single cells 3 are arranged on the heat conducting plate 2 with their longitudinal axes parallel to one another.

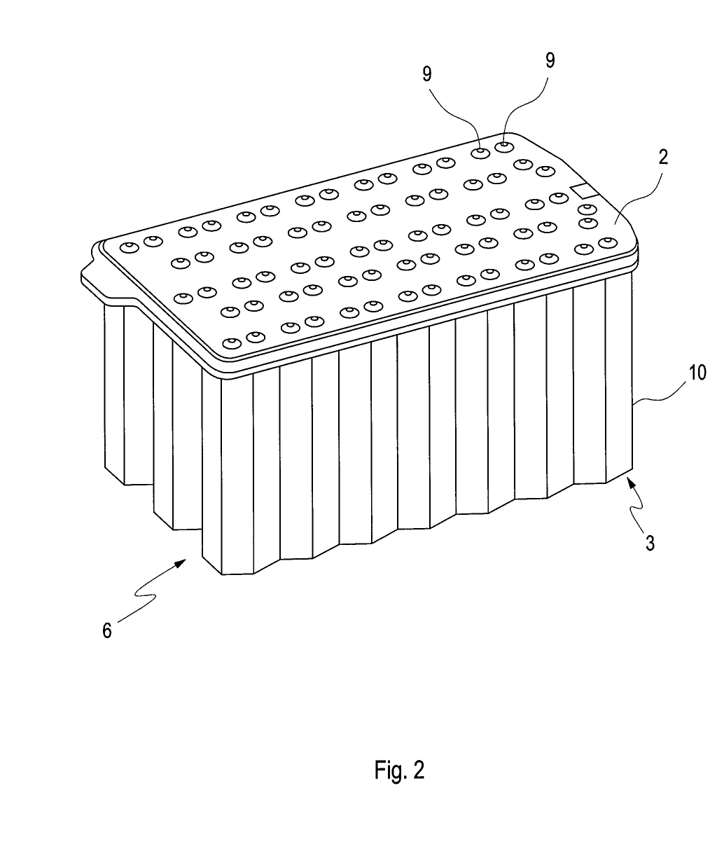

FIG. 2 is a perspective view of a cell stack 6 formed of several single cells 3 of a battery according to the invention, with a heat conducting plate 2 arranged at the top, so that the single cells 3 are thermally coupled. Especially due to the packing density of the single cells 3 of the present cell stack 6, the cross section of the single cells 3 is a regular hexagon in this case. However, all possible round, oval or polygonal cross sections and cylindrical or prismatic designs of single cells 3 connected therewith are feasible in principle.

The heat conducting plate 2, which is preferably made of a metal, is provided for temperature control of the battery. It has a channel structure which is formed by cooling channels 5, and can be operated from the outside, for guiding a flow of a heat conducting medium through its interior. According to the invention, the heat conducting plate 2 is arranged between the cell housing covers 7 of the single cells 3 and the electrical cell connectors 8 (FIG. 6), which electrically connect oppositely poled poles 9 of adjacent single cells 3. The poles 9 of each single cell 3 are extended via associated bores arranged in the heat conducting plate 2 and in an electrically insulated manner and also preferably in a heat conducting manner on the flat side turned away from the cell housing cover 7 of the single cells 3.

When a battery 1 according to the invention is used, especially as a traction and traction aid battery of a motor vehicle, the cooling channels 5 can be connected to an air conditioning unit (not shown) already present in the vehicle, and supplied by this at least partially on the heat side. This heat supply can be connected directly to the air conditioning unit, for example via a common heat conducting medium, especially a fluid. It can also cooperate indirectly with the air conditioning unit, for example via a heat exchanger. The heat conducting medium can also comprise the air escaping from the air-conditioned interior of the motor vehicle and/or can be supplied with this air.

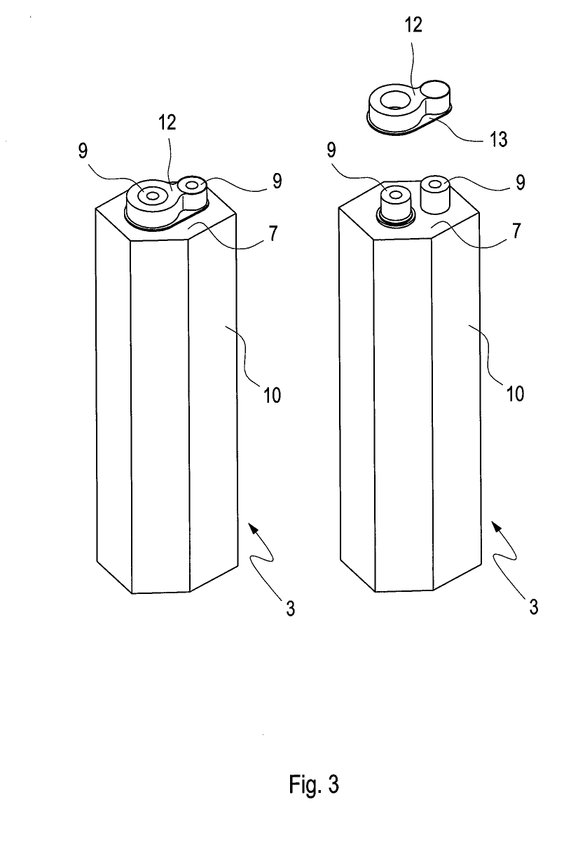

FIG. 3 shows two single cells 3 of the cell stack 6 according to FIG. 2. In the left single cell 3, an insert piece 12 is arranged directly around the poles 9 of the single cell 3 and abuts them directly. In the right single cell 3, the insert piece 12 is lifted off and shown above the poles 9.

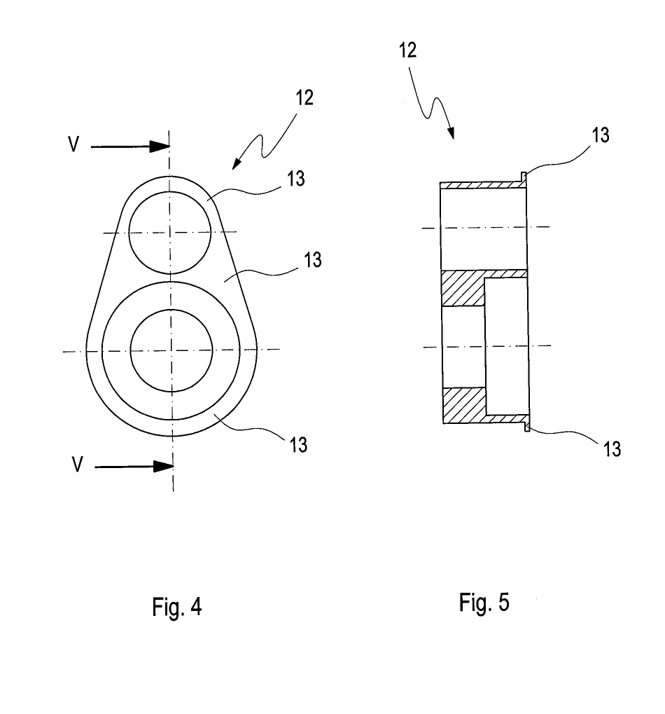

As shown in FIGS. 3 to 5, the one-piece insert piece 12 is arranged at both poles 9 of the single cell 3. To secure against a mix-up during mounting, the two poles 9 of a single cell 3 are formed differently. As the insert piece 12 directly abuts the outer surface of the poles 9, and is thus adapted to the physical dimensions of the poles 9 of a single cell 3, the feed-throughs of the insert piece 12 adapted to this design of the poles 9 are formed correspondingly. This adapted formation, where each feed-through of the insert piece 12 completely surrounds the outer surface of the associated pole 12, also ensures correct mounting of the insert piece 12.

The insert piece 12 is made of an electrically insulating, and preferably also an especially highly heat conductive, material. At the edge region of the insert piece 12 assigned to the cell housing cover 7, a spacing collar 13 which extends radially from the pole 9 and progresses continuously, is arranged at least in sections at a distance between the cell housing cover 7 and the heat conducting plate 2. The heat conducting plate 2 and the single cells 3 are pressed together by joining measures during production, so that the spacing collar 13 has direct contact with the cell housing cover 7 and the heat conducting plate 2 in a preferred manner. The heat conducting plate 2 has an electrically insulating distance from the cell housing covers 7 by means of the spacing collar 13. The heat conducting plate 2 is also arranged in an electrically insulating manner with a distance from the cell connectors 8.

FIG. 6 is a longitudinal sectional side view of a cell stack 6 according to the invention. In a battery 1 (FIG. 1) according to the invention with a cell stack 6 according to FIG. 2, the heat conducting plate 2 is arranged at the top, and thereby in the region of the poles 9 of the single cells 3. The cell housings 10 of the single cells 3 aligned parallel to their longitudinal extension have a mutual distance on their outer surface. Both poles 9 of a single cell 3 project through a single bore arranged in the heat conducting plate 2 and assigned to these poles 9 to the flat side 11 of the heat conducting plate 2 opposite the cell housing covers 7. The cell connectors 8 are on this side.

As the form and the clear mass of such a bore is larger than the outer dimensions around the poles 9 of a single cell 3, the poles 9 extending through the bores have a distance from the walls of the bore everywhere. Thus, the poles 9 and the heat conducting plate 2 do not make contact, and are mutually insulated electrically. The electrical insulation is especially improved or ensured by insert pieces 12, which are arranged around the poles 9 of a single cell 3.

To improve the mutual electrical insulation of the components arranged within the battery housing 4, increase the stability of the entire battery housing 4, and improve the entire heat conductability, an electrically insulating and preferably heat-conductive (most preferably highly heat-conductive) casting compound and/or foam is arranged in the gaps between the heat conducting plate 2 on the one hand and the poles 9, and the electrical cell connectors 8 and the cell housing cover 7, and also the cover of the battery housing, which preferably completely fills these gaps.

Electrically insulating but heat-conducting materials, such as polyurethane foams, epoxy resins and/or silicones, have proved themselves for use as the casting compound 14. The respective free spaces are cast with as few bubbles as possible (and especially preferably, free from bubbles) with these preferred materials. In an advantageous manner, the materials for the casting compound 14 can be improved further with regard to their heat conduction by adding heat-conducting particles, which are distributed in the material in the manner of a well mixed mixture. In an advantageous manner, the free spaces between the walls of adjacent cell housings 10 and also the free spaces between the walls of the cell housings 10 and the wall of the battery housing 4 and/or a cell stack cup (not shown) receiving the cell stack 6 and preferably arranged within the battery housing 4 with a distance thereto, are filled in the same manner. When a cell stack cup is used and thereby a virtually double-walled battery housing 4, this gap formed by the double wall can additionally accommodate a flow of a heat conducting medium.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-13. (canceled)

14. A battery comprising:
a heat conducting plate for temperature control of the battery;
a plurality of single cells which are electrically interconnected and are thermally coupled to the heat conducting plate, and each of which has two poles; and
a channel structure arranged in the heat conducting plate for guiding a flow of a heat conducting medium therein; and
connection cross sections for the channel structure extending from the heat conducting plate; wherein,
the heat conducting plate has bores in a region of the poles of the single cells;
the poles of the single cells project through the bores;
an insert piece of an electrically insulating material is arranged around a pole of a single cell;
the insert piece abuts the outer surface of the pole at least in sections;
the insert piece has at least one spacing collar extending at least radially from the pole; and
the spacing collar of the insert piece is arranged in a region of the poles between a cell housing cover of the single cell and the heat conducting plate.

15. The battery according to claim 14, wherein the spacing collar extends radially from the pole and progresses at an edge of the insert piece in an uninterrupted continuous manner.

16. The battery according to claim 14, wherein the insert piece is made of a heat-conducting material.

17. The battery according to claim 14, wherein both poles of a single cell have a single, one-piece insert piece.

18. The battery according to claim 14, wherein the insert piece surrounds substantially completely the outer surface of a pole.

19. The battery according to claim 14, wherein the heat conducting plate is made of a metal.

20. The battery according to claim 14, wherein a clear width of the bores is larger than an outer diameter of a respective pole.

21. The battery according to claim 14, wherein a form and clear measurements of a bore are larger than outer dimensions of both poles of a single cell.

22. The battery according to claim 14, wherein an electrically insulating and heat-conductive casting compound or foam is arranged within the battery housing in a gap between the heat conducting plate and the poles.

23. The battery according to claim 14, wherein an electrically insulating and heat-conductive casting compound or foam is arranged within the battery housing in a gap between the heat conducting plate and electrical connectors.

24. The battery according to claim 14, wherein an electrically insulating and heat-conductive casting compound or foam is arranged within the battery housing in a gap between the heat conducting plate and the cell housing cover.

25. The battery according to claim 14, wherein an electrically insulating and heat-conductive casting compound or foam is arranged within the battery housing in a gap between the heat conducting plate and a cover of the battery housing.

26. The battery according to claim 22, wherein the gap is completely filled by the casting compound or foam.

27. The battery according to claim 23, wherein the gap is completely filled by the casting compound or foam.

28. The battery according to claim 24, wherein the gap is completely filled by the casting compound or foam.

29. The battery according to claim 25, wherein the gap is completely filled by the casting compound or foam.
